(19) United States
(12) Patent Application Publication
(10) Pub. No.: US 2026/0059458 A1
(43) Pub. Date: Feb. 26, 2026

(54) DELIVERY OF CLOCK QUALITY INFORMATION TO USER EQUIPMENT

(71) Applicant: QUALCOMM Incorporated, San Diego, CA (US)

(72) Inventors: Sebastian SPEICHER, Wallisellen (CH); Haris ZISIMOPOULOS, London (GB)

(21) Appl. No.: 19/105,767

(22) PCT Filed: Nov. 1, 2023
(86) PCT No.: PCT/US2023/078417

§ 371 Date: Feb. 21, 2025

(30) Foreign Application Priority Data
Nov. 3, 2022 (GR) 20220100895

(51) Int. Cl. H04W 56/00; H04W 24/10

(52) U.S. Cl. CPC H04W 56/001; H04W 24/10

(57) ABSTRACT

An apparatus has one or more memories and one or more processors coupled to the one or more memories. The processor(s) is configured to receive clock quality reporting control information. The processor(s) is also configured to transmit clock quality information to a user equipment (UE) based on the clock quality reporting control information.

### CROSS-REFERENCE TO RELATED APPLICATION

The present application claims the benefit of Greece Patent Application Serial No. 20220100895, filed on Nov. 3, 2022, and titled “DELIVERY OF CLOCK QUALITY INFORMATION TO USER EQUIPMENT,” the disclosure of which is expressly incorporated by reference in its entirety.

### FIELD OF THE DISCLOSURE

The present disclosure relates generally to wireless network time synchronization, and more specifically to efficient delivery of clock quality information to user equipment (UE).

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IoT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail, a BS may be referred to as a Node B, an evolved Node B (eNB), a gNB, an access point (AP), a radio head, a transmit and receive point (TRP), a new radio (NR) BS, a 5G Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

### SUMMARY

Aspects of the present disclosure are directed to an apparatus. The apparatus has at least one memory and one or more processors coupled to the memory. The processor(s) is configured to receive clock quality reporting control information. The processor(s) is also configured to transmit clock quality information to a user equipment (UE) based on the clock quality reporting control information.

In aspects of the present disclosure, a method for wireless communication by a network device includes receiving clock quality reporting control information. The method also includes transmitting clock quality information to a user equipment (UE) based on the clock quality reporting control information.

In other aspects of the present disclosure, a non-transitory computer-readable medium with program code recorded thereon is disclosed. The program code is executed by a processor and includes program code to receive clock quality reporting control information. The program code also includes program code to transmit clock quality information to a user equipment (UE) based on the clock quality reporting control information.

Other aspects of the present disclosure are directed to an apparatus. The apparatus includes means for receiving clock quality reporting control information. The apparatus also includes means for transmitting clock quality information to a user equipment (UE) based on the clock quality reporting control information.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a block diagram illustrating an example disaggregated base station architecture, in accordance with various aspects of the present disclosure.

FIG. 4 is a timing diagram illustrating communication of clock quality information, in accordance with various aspects of the present disclosure.

FIG. 5 is a block diagram of an example wireless communication device that supports delivery of clock quality information, in accordance with various aspects of the present disclosure.

FIG. 6 is a block diagram of an example wireless communication device that supports delivery of clock quality information, in accordance with various aspects of the present disclosure.

FIG. 7 is a flow diagram illustrating an example process performed, for example, by a network device, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G and/or 4G technologies.

Network time synchronization enables network devices to accurately time stamp information based on clock information received from a network. For example, a bank may time stamp a financial transaction based on the network time. The quality of the network time information needed by user equipment (UE) varies by application. For example, a banking application may specify an accuracy within 500 ms, whereas a scientific application or a utilities application may specify the accuracy to the nearest nanosecond. Different network components may offer different levels of clock accuracy. It would be desirable for the network to be able to efficiently indicate, to the UEs, the accuracy of the network time provided by that network device.

Functionality has been specified to enable a next generation radio access network (NG-RAN) to provide network time of a fifth generation (5G) system (e.g., denoted reference time), or sixth generation (6G) system, to a UE, either using a system information block (SIB) or unicast radio resource control (RRC) signaling. The UE makes the reference time available to devices attached to the UE. The time reference may be used as a primary or backup clock for time service consumers, for example, financial institutions, utilities, etc.

To enable the use of the reference time as a primary or backup clock, clock quality information may be provided to the UE. Clock quality information may include information about the quality of the 5G clock, for example, traceability to Coordinated Universal Time (UTC), clock accuracy, frequency stability, etc. By providing the clock quality information to the UE, a time service consumer can determine whether the quality of the 5G clock can fulfill its requirements.

Clock synchronization may occur because some operation or process depends on the synchronization. For example, robot arms in a factory may need to operate in coordination, which requires clock synchronization. Similarly, power grid sub stations may need to operate in phase, which requires clock synchronization. If the synchronization cannot be guaranteed, the operations may be paused to prevent malfunctions. Clock quality information is a key decision criterion to determine whether operations/processes can safely continue. In another example, banks may be required by regulation to document (e.g., by keeping log files) whether their clocks are UTC traceable. This documentation may be required by the market in financial instruments directive (MIFID) II regulations in Europe, for example.

Not only should clock quality information be provided to the UE, but which type of clock quality information to provide to the UE should also be configured. Aspects of the present disclosure introduce solutions to increase the efficiency of providing, to the UE, clock quality information about individual radio access network nodes (e.g., base stations). In some aspects, the network controls whether clock information is to be provided at all, and if so, what level of detail of clock quality information to provide to the UEs. That is, which information the UEs receive is individually configured. Each UE may receive a different level of detail.

Some aspects enable the network to indicate, to a UE, whether the network clock quality fulfills clock quality requirements for a specific UE. For example, the base station may indicate, to the UE, whether the clock quality of the base station fulfills an agreement with a specific time service consumer. In other words, the base station indicates whether the clock quality is an acceptable clock quality for the specific UE.

In some aspects, unified data management (UDM) subscriptions may be configured with information about a clock quality detail level. The clock quality detail level indicates whether and which clock quality information is to be provided to the UE. In some implementations, the clock quality detail level can specify a clock quality index, clock quality details, or an indication of whether the clock quality satisfies clock quality acceptance criteria for the UE (e.g., acceptable/not acceptable indication). In aspects when the subscription does not provide the clock quality configuration, a clock quality detail level may be provided based on an application program interface (API) request.

In other aspects of the present disclosure, default clock quality is signaled to the UE for an area in which the UE may be located. By signaling the default clock quality, efficiency for clock quality signaling is improved. The area may be a cell of the base station, a tracking area shared by multiple base stations, or another type of area. In these aspects, the network provides a default clock quality to the UEs located within the area. The network may override the default information, for example, by broadcasting more specific information from the base station. In this case, the UE connects to the network to receive clock quality details from the RAN nodes that broadcast more specific information.

Particular aspects of the subject matter described in this disclosure can be implemented to realize one or more of the following potential advantages. In some examples, the described techniques, such as receiving clock quality reporting control information, transmitting clock quality information to a user equipment (UE) based on the clock quality reporting control information, and/or transmitting a default clock quality to a UE may improve efficiency of network time synchronization. For example, because signaling is reduced by avoiding active connections from the UE to the network, the time synchronization is more efficient.

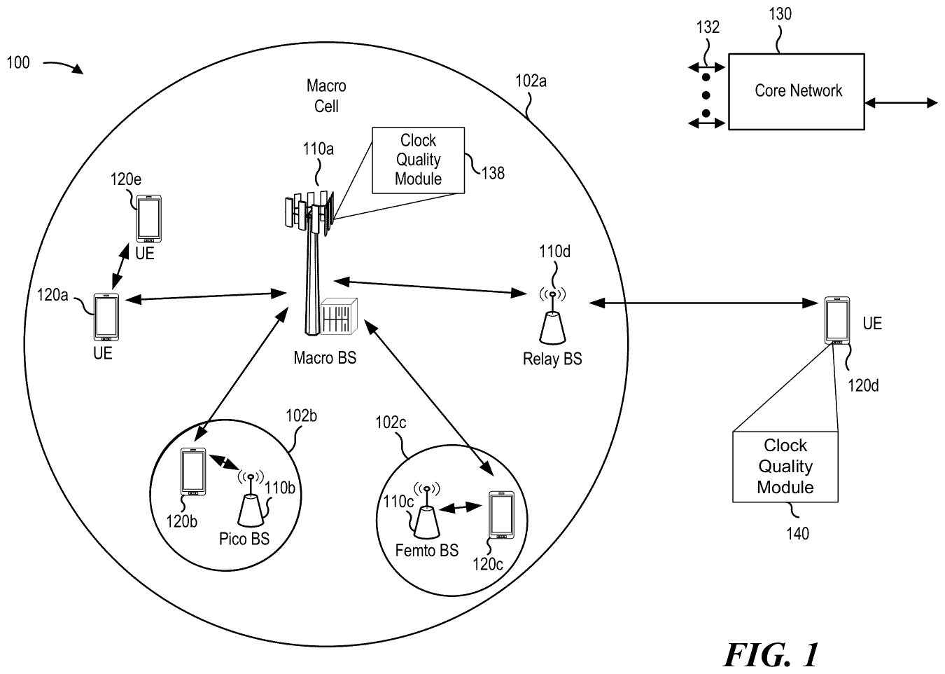

FIG. 1 is a diagram illustrating a network 100 in which aspects of the present disclosure may be practiced. The network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G Node B, an access point, a transmit and receive point (TRP), a network node, a network entity, and/or the like. A base station can be implemented as an aggregated base station, as a disaggregated base station, an integrated access and backhaul (IAB) node, a relay node, a sidelink node, etc. The base station can be implemented in an aggregated or monolithic base station architecture, or alternatively, in a disaggregated base station architecture, and may include one or more of a central unit (CU), a distributed unit (DU), a radio unit (RU), a near-real time (near-RT) RAN intelligent controller (RIC), or a non-real time (non-RT) RIC.

Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB,” “base station.” “NR BS,” “gNB,” “AP,” “Node B,” “5G NB,” “TRP,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types (e.g., macro BSs, pico BSs, femto BSs, relay BSs, and/or the like). These different types of BSs may have different transmit power levels, different coverage areas, and different impact on interference in the wireless network 100. For example, macro BSs may have a high transmit power level (e.g., 5 to 40 watts) whereas pico BSs, femto BSs, and relay BSs may have lower transmit power levels (e.g., 0.1 to 2 watts).

As an example, the BSs 110 (shown as BS 110a, BS 110b, BS 110c, and BS 110d) and the core network 130 may exchange communications via backhaul links 132 (e.g., S1, etc.). Base stations 110 may communicate with one another over other backhaul links (e.g., X2, etc.) either directly or indirectly (e.g., through core network 130).

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking. IP connectivity, and other access, routing, or mobility functions. One or more of the base stations 110 or access node controllers (ANCs) may interface with the core network 130 through backhaul links 132 (e.g., S1, S2, etc.) and may perform radio configuration and scheduling for communications with the UEs 120. In some configurations, various functions of each access network entity or base station 110 may be distributed across various network devices (e.g., radio heads and access network controllers) or consolidated into a single network device (e.g., a base station 110).

UEs 120 (e.g., 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless network 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

The UEs 120 may include a clock quality module 140. For brevity, only one UE 120d is shown as including the clock quality module 140. The clock quality module 140 may receive a first default clock quality for a first area, and apply the first default clock quality, when the UE is located within the first area. The clock quality module 140 may also receive a second default clock quality for a second area when the UE leaves the first area and enters the second area, and apply the second default clock quality, when the UE is located within the second area.

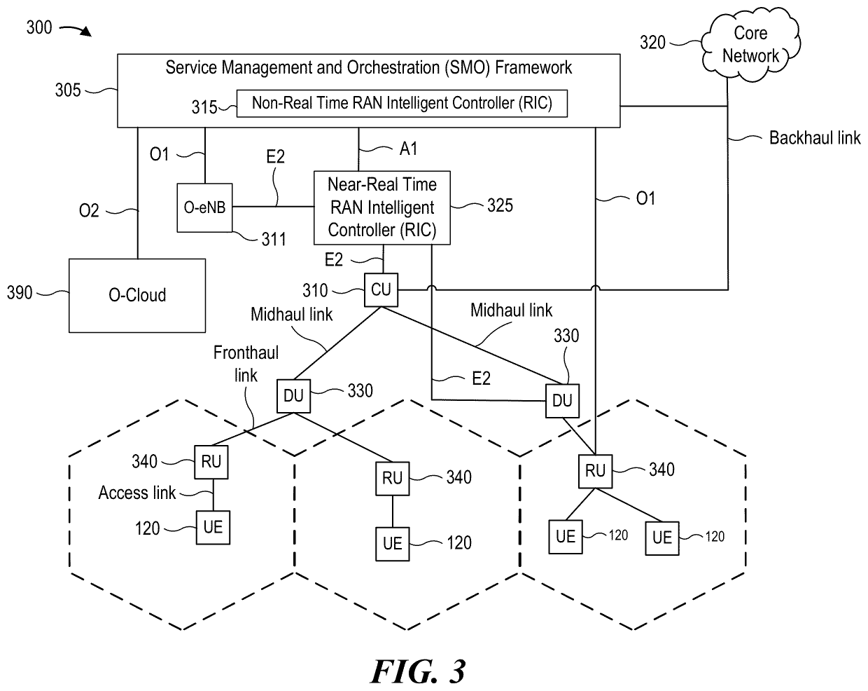

The core network 130 or the base stations 110 or any other network device (e.g., as seen in FIG. 3) may include a clock quality module 138 for network time synchronization. The clock quality module 138 may receive clock quality reporting control information; and transmit clock quality information to a user equipment (UE) based on the clock quality reporting control information. In some aspects, the clock quality module 138 may transmit a default clock quality to a user equipment (UE), the default clock quality applying to an area of the network device.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrow band internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases. NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (e.g., a system information block (SIB).

As indicated above. FIG. 1 is provided merely as an example. Other examples may differ from what is described with regard to FIG. 1.

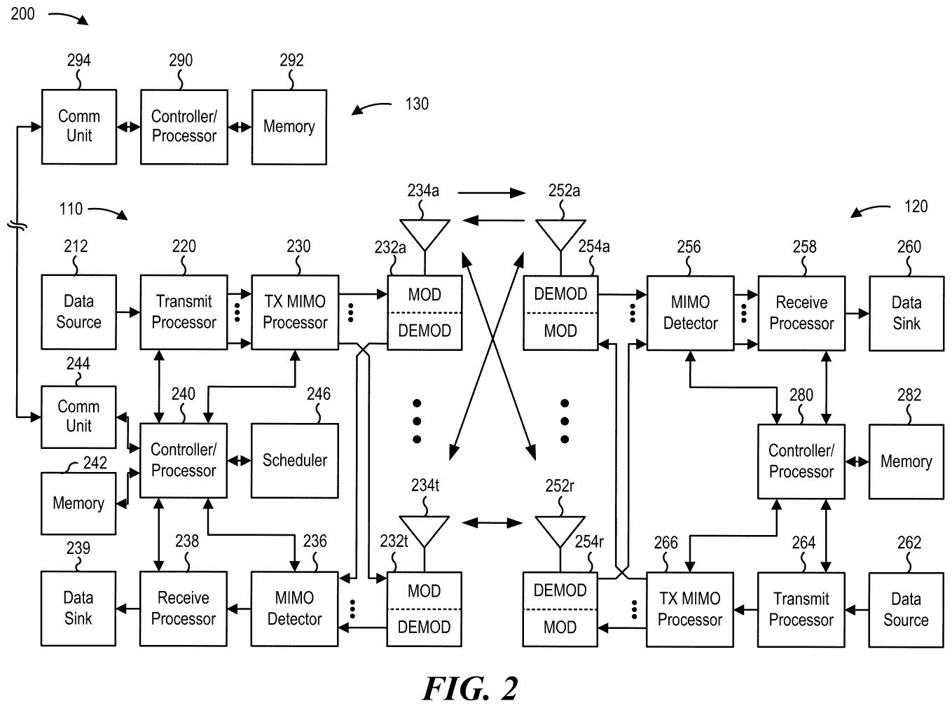

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Decreasing the MCS lowers throughput but increases reliability of the transmission. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for orthogonal frequency division multiplexing (OFDM) and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below; the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (e.g., for discrete Fourier transform spread OFDM (DFT-s-OFDM), CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

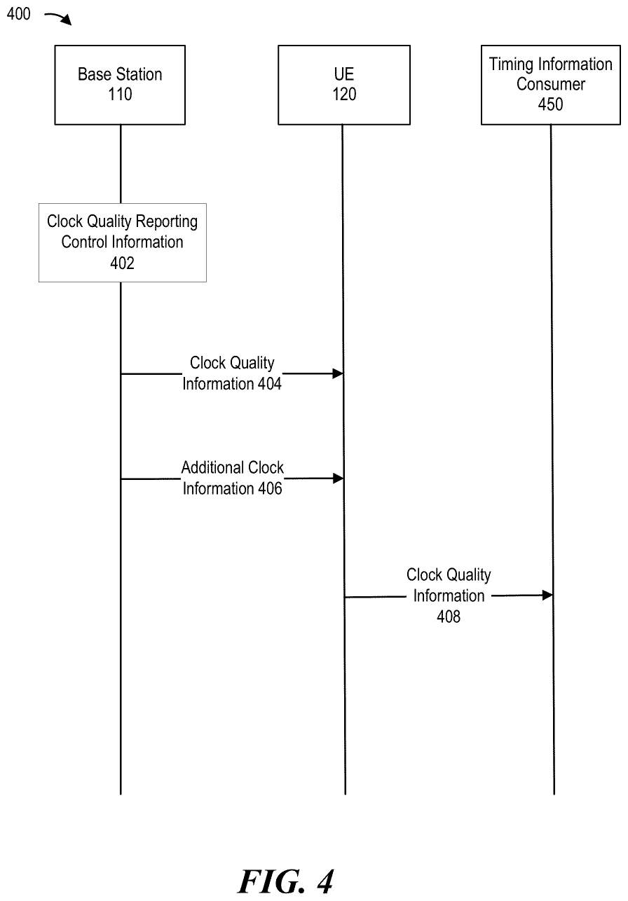

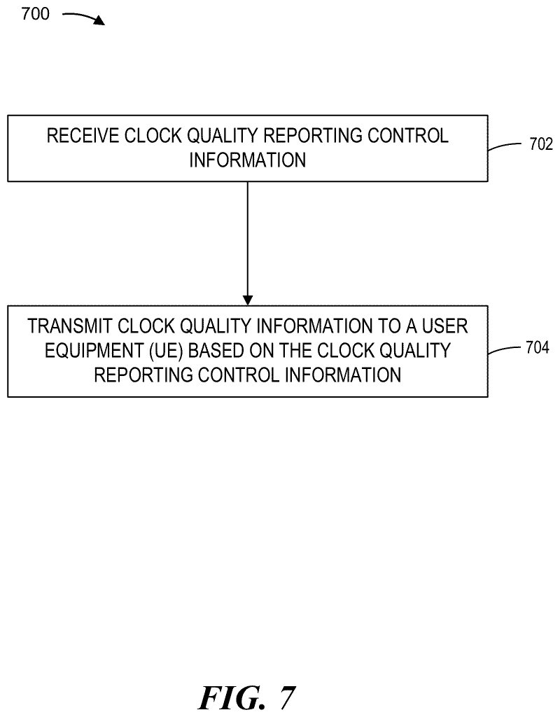

The controller/processor 240 of the base station 110, the controller/processor 280 of the UE 120, and/or any other component(s) of FIG. 2 may perform one or more techniques associated with delivery of clock quality information, as described in more detail elsewhere. For example, the controller/processor 240 of the base station 110, the controller/processor 280 of the UE 120, and/or any other component(s) of FIG. 2 may perform or direct operations of, for example, the processes of FIGS. 4 and 7 and/or other processes as described. Memories 242 and 282 may store data and program codes for the base station 110 and UE 120, respectively. A scheduler 246 may schedule UEs for data transmission on the downlink and/or uplink.

In some aspects, the UE 120 and/or base station 110 may include means for receiving, means for transmitting, means for transmitting, means for broadcasting, and means for applying. Such means may include one or more components of the UE 120 or base station 110 described in connection with FIG. 2.

As indicated above, FIG. 2 is provided merely as an example. Other examples may differ from what is described with regard to FIG. 2.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (eNB), an NR BS, 5G NB, an access point (AP), a transmit and receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operations or network designs may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In some cases, different types of devices supporting different types of applications and/or services may coexist in a cell. Examples of different types of devices include UE handsets, customer premises equipment (CPEs), vehicles, Internet of Things (IoT) devices, and/or the like. Examples of different types of applications include ultra-reliable low-latency communications (URLLC) applications, massive machine-type communications (mMTC) applications, enhanced mobile broadband (eMBB) applications, vehicle-to-anything (V2X) applications, and/or the like. Furthermore, in some cases, a single device may support different applications or services simultaneously.

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real time (near-RT) RAN intelligent controller (RIC) 325 via an E2 link, or a non-real time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., central unit-user plane (CU-UP)), control plane functionality (e.g., central unit-control Plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO framework 305 may be configured to support RAN deployment and provisioning of non-virtualized and virtualized network elements. For non-virtualized network elements, the SMO framework 305 may be configured to support the deployment of dedicated physical resources for RAN coverage requirements, which may be managed via an operations and maintenance interface (such as an O1 interface). For virtualized network elements, the SMO framework 305 may be configured to interact with a cloud computing platform (such as an open cloud (O-cloud) 390) to perform network element life cycle management (such as to instantiate virtualized network elements) via a cloud computing platform interface (such as an O2 interface). Such virtualized network elements can include, but are not limited to CUs 310. DUs 330. RUs 340, and near-RT RICs 325. In some implementations, the SMO framework 305 can communicate with a hardware aspect of a 4G RAN, such as an open eNB (O-eNB) 311, via an O1 interface. Additionally, in some implementations, the SMO framework 305 can communicate directly with one or more RUs 340 via an O1 interface. The SMO framework 305 also may include a non-RT RIC 315 configured to support functionality of the SMO framework 305.

The non-RT RIC 315 may be configured to include a logical function that enables non-real-time control and optimization of RAN elements and resources, artificial intelligence/machine learning (AI/ML) workflows including model training and updates, or policy-based guidance of applications/features in the near-RT RIC 325. The non-RT RIC 315 may be coupled to or communicate with (such as via an A1 interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as the O-eNB 311, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO framework 305 or the non-RT RIC 315 from non-network data sources or from network functions. In some examples, the non-RT RIC 315 or the near-RT RIC 325 may be configured to tune RAN behavior or performance. For example, the non-RT RIC 315 may monitor long-term trends and patterns for performance and employ AI/ML models to perform corrective actions through the SMO framework 305 (such as reconfiguration via O1) or via creation of RAN management policies (such as A1 policies).

Network time synchronization enables network devices to accurately time stamp information based on clock information received from a network. A network typically has a primary reference time clock that provides the time for other clocks in the network and which is usually synchronized with an external time source that provides time according to a recognized time standard (e.g., UTC). The network makes this time signal available to network devices. For example, a bank may time stamp a financial transaction based on the network time. The quality of the network time information needed by user equipment (UEs) varies by application. For example, a bank application may specify time accuracy to within 500 ms, whereas a scientific application or utilities application (e.g., power grid management) may specify the accuracy to the nearest nanosecond. Different network components may offer different levels of clock accuracy. It would be desirable for the network to be able to efficiently indicate to the UEs the accuracy of the network time provided by that network device.

In Release 16 (Rel-16), the Third Generation Partnership Project (3GPP) specified functionality to enable a next generation radio access network (NG-RAN) to provide the time of the fifth generation (5G) system (e.g., denoted reference time) to the UE either using a system information block (SIB) or unicast radio resource control (RRC) signaling. The UE makes the reference time available to devices attached to the UE, for example, using a one packet per second (PPS) output or by means of the Precision Time Protocol (PTP). The time reference may also be used as a primary or backup clock for time service consumers, for example, financial institutions, utilities, etc.

To enable the use of the reference time as a primary or backup clock, clock quality information may be provided to the UE. Clock quality information may include information about the quality of the 5G clock, for example, traceability to Coordinated Universal Time (UTC), clock accuracy, frequency stability, etc. By providing the clock quality information to the UE, a time service consumer can determine whether the quality of the 5G clock can fulfill its requirements.

Different solutions have been proposed to provide UEs with clock quality information about individual radio access network (RAN) nodes (e.g., base stations). For example, the base station may broadcast a flag and a report identification (ID) to inform the UE that a new report with network clock quality information is available. The base station may also broadcast a flag and a timestamp to inform the UE that a new report with network clock quality information is available. Upon receiving the broadcast, the UE determines, based on the report ID or the timestamp, whether a new report about the clock quality of the current cell is available. To obtain details about the actual clock quality of the cell, the UE establishes a radio resource control (RRC) connection with the base station to allow the base station to deliver the clock quality report to the UE.

These solutions are inefficient, however, because of the amount of signaling involved. Mobile UEs that use network time synchronization need to actively connect to the network to obtain the clock quality report for every cell on which the UE camps. This process may lead to a large amount of signaling, depending on the number of UEs using network time synchronization. These solutions intentionally do not provide clock quality information, for example, in system information broadcast (SIB) messages, to prevent misuse of such information if the information was made available to any UE.

Not only should clock quality information be provided to the UE, but which type of clock quality information to provide to the UE should also be considered. Aspects of the present disclosure introduce solutions to increase the efficiency of providing, to the UE, clock quality information about individual radio access network nodes (e.g., base stations). In some aspects, the network controls whether clock information is to be provided at all, and if so, what level of detail of clock quality information to provide to the UEs. That is, which information the UE receives is individually configured. Each UE may receive a different level of detail.

Other aspects enable the network to indicate to the UE whether the network clock quality fulfills the clock quality requirements for a specific UE. In these aspects, the base station indicates to the UE whether the clock quality of the base station fulfills an agreement with a specific time service consumer. In other words, the base station indicates whether the clock quality is an acceptable clock quality for a specific UE.

In some aspects, unified data management (UDM) subscriptions may be configured with information about a clock quality detail level. The clock quality detail level indicates whether and which clock quality information is to be provided to the UE. In some implementations, the clock quality detail level can specify a clock quality index, clock quality details, or an indication of whether the clock quality satisfies clock quality acceptance criteria for the UE (acceptable/not acceptable indication). The acceptance criteria may include multiple different criteria types to be verified in order to indicate whether the clock quality is acceptable. The UDM subscription holds information about all subscribers to authenticate and authorize UEs for network access and also holds information about services a subscriber can use. For example, whether a UE can use time synchronization services is configured in the UDM. According to aspects of the present disclosure, clock quality reporting control information may be included in the subscription information in the UDM.

A clock quality index provides a quality index to the UE, such as a dimensionless value, which refers to clock accuracy levels for which the details are known. For example, the information may be available separately (e.g., using offline processes) from the network operator. If clock quality details are configured, the information provided to the UE may include, for example, clock accuracy, frequency stability, and/or traceability to UTC. The acceptable/not acceptable indication informs the UE of whether the clock quality meets an acceptable clock quality for the UE, that is, whether the clock quality satisfies the clock quality acceptance criteria for the UE. In some aspects, if the clock quality level is the acceptable/not acceptable indication, the network determines whether to indicate acceptable or not acceptable to the UE based on a set of acceptable clock indices configured in the network for the UE. These indices may be pre-agreed. In one example, a first index corresponds to 100 ms of accuracy with a first level of frequency stability and a second index corresponds to 500 ms of accuracy with a second level of frequency stability. In some aspects, the clock quality level is the acceptable/not acceptable indication. Alternatively, the network determines whether to indicate acceptable or not acceptable to the UE based on clock quality acceptance criteria. Clock quality acceptance criteria may include acceptable clock accuracy, acceptable frequency stability, etc.

In aspects when the subscription does not provide the clock quality configuration, a clock quality detail level may be provided based on an application program interface (API) request. In these aspects, an application function (AF) provides the clock quality detail level and the set of acceptable clock indices or clock quality acceptance criteria to the network. This information may be provided, for example, when requesting time synchronization for the UE.

The network can inform individual UEs whether the clock quality fulfills the acceptable clock quality for the UE. In a first base station-based configuration, the clock quality detail level and, optionally, a set of acceptable clock indices (also referred to as clock classes or clock levels) or clock quality acceptance criteria are configured in the subscription or have been signaled by an AF. In this first base station-based configuration, the core network provides the clock quality detail level and the set of acceptable clock classes or clock quality acceptance criteria to the base station. The core network may provide the information, for example, when establishing the UE context in the RAN.

In another base station-based configuration, the base station has received clock quality detail level information and, optionally, the set of acceptable clock indices or clock quality acceptance criteria from the core network. In this second base station-based configuration, the base station provides the following information to the UE based on the received clock quality detail level. The clock quality detail level may be a clock quality index, clock quality details, or an acceptable/not acceptable indication. If the clock quality index is configured, the base station provides a quality index to the UE that reflects the current clock quality of the RAN node (e.g., base station). If the clock quality details are configured, the base station provides clock quality details to the UE where the clock quality details reflect the current clock quality of the RAN node. If the acceptable/not acceptable indication is configured, the base station indicates “Acceptable” to the UE if the clock quality of the network matches one of the acceptable clock classes or clock quality acceptance criteria received from the core network. Otherwise, the base station indicates “Not Acceptable.”

In a core network-based configuration, the core network, for example, the access and mobility management function (AMF), evaluates the clock quality detail level information and optionally the set of acceptable clock indices or clock quality acceptance criteria from the subscription or received from the AF. The core network then provides the clock quality index, clock quality details, or the acceptable/not acceptable indication to the UE. In some implementations, the core network provides the information to the UE with non-access stratum (NAS) signaling.

In other aspects of the present disclosure, default clock quality is signaled to the UE for an area in which the UE is located. By signaling a default clock quality, efficiency is improved for providing clock quality information to the UE. The area may be a cell of the base station, a tracking area shared by multiple base stations, or another type of area. In these aspects, the network provides a default clock quality to the UE that applies, unless a base station broadcasts more specific information. In these aspects, the UE only connects to the network to receive clock quality details for RAN nodes when the clock quality details deviate from the default clock quality, as indicated by the more specific information. Either the base station or the core network, for example, the AMF, may signal the default clock quality to the UE.

In implementations where a base station signals the default network clock quality, the base station is configured (e.g., using operations, administration, and maintenance (OAM) procedures) with the default clock quality index and the related default clock quality details. If the base station has received, from the core network, the clock quality detail level information, and, optionally, the set of acceptable clock indices or clock quality acceptance criteria, then the base station provides the default network clock quality information to the UE based on the received clock quality detail level. The clock quality information may include a clock quality index that provides the configured default network clock quality index to the UE. The clock quality information may alternatively include clock quality details providing the configured default network clock details to the UE. The clock quality information may alternatively include an acceptable/not acceptable indication, which indicates “Acceptable” to the UE if the configured default clock quality matches one of the acceptable clock classes or clock quality acceptance criteria received from the core network, and “Not Acceptable” otherwise.

If the UE has received the default clock quality from a base station, in some aspects, the UE uses the same default clock quality for other base stations that broadcast the same tracking area as the base station that provided the default clock quality. Thus, the UE need not communicate with each base station to obtain clock quality information. In these aspects, the area covered by the default clock quality is a tracking area, as opposed to a cell. If a UE enters a tracking area for which the UE does not have the default network clock quality, the UE may establish a connection (e.g., an RRC connection) with the base station to enable the base station to provide the UE with default network clock quality information for the new tracking area.

In some aspects, the base station (or core network) may additionally include a list of tracking areas to which the default clock quality applies. For example, the list may include adjacent tracking areas. If the UE has received the default clock quality and the list of tracking areas from a base station or the core network, then the UE uses the same default clock quality for all base stations that broadcast one of the listed tracking areas. If the UE enters a tracking area for which the UE does not have the default network clock quality, the UE may establish a connection (e.g., an RRC connection) to enable the RAN or core network to provide the UE with default network clock quality information for the new tracking area.

Although the present disclosure has been described with respect to a default clock quality, the present disclosure is not so limited. The disclosure can also be generalized and can be used to efficiently provide other cell-specific information that is common to most base stations in an area (e.g., most base stations in a tracking area), but where the cell-specific information for some base stations in the area deviates from the default values.

FIG. 4 is a timing diagram illustrating communication of clock quality information, in accordance with various aspects of the present disclosure. In the example of FIG. 4, a wireless network 400 includes a base station 110, a UE 120 and a timing information consumer 450. At 402, clock quality reporting control information is processed at the base station 110. The clock quality reporting control information may be received, for example, from an AF or a subscription database.

At 404, the base station 110 transmits clock quality information to the UE 120. The base station 110 may provide information to the UE 120 based on the received clock quality reporting control information. For example, the base station 110 may not transmit clock quality information (not shown in FIG. 4) based at least in part on the clock quality reporting information for a UE indicating not to transmit the clock quality information to the UE. In the example of FIG. 4, the clock quality information may include a clock quality index, clock quality details, or an acceptable/not acceptable indication. If the clock quality index is configured, the base station 110 provides a quality index to the UE 120 that reflects the current clock quality of the RAN node (e.g., base station). If the clock quality details are configured, the base station 110 provides clock quality details to the UE 120 where the clock quality details reflect the current clock quality of the RAN node. If the acceptable/not acceptable indication is configured, the base station 110 indicates a first value (e.g., “0” or “Acceptable”) to the UE 120 if the clock quality of the network satisfies one of the acceptable clock classes received from the core network. The base station 110 indicates a second value (e.g., “1” or “Not Acceptable”) otherwise. In some aspects, the network provides the default clock quality. If a default clock quality is configured, the base station 110 transmits the default clock quality information at 404. If the clock quality of the current area (e.g., cell) deviates from the default clock quality, the base station 110 provides the first UE-1 with additional clock quality information of the current cell, at 406.

At 408, the UE 120 provides the clock quality information to the timing information consumer 450. If the default clock quality is configured and current, the UE 120 signals the default clock quality information.

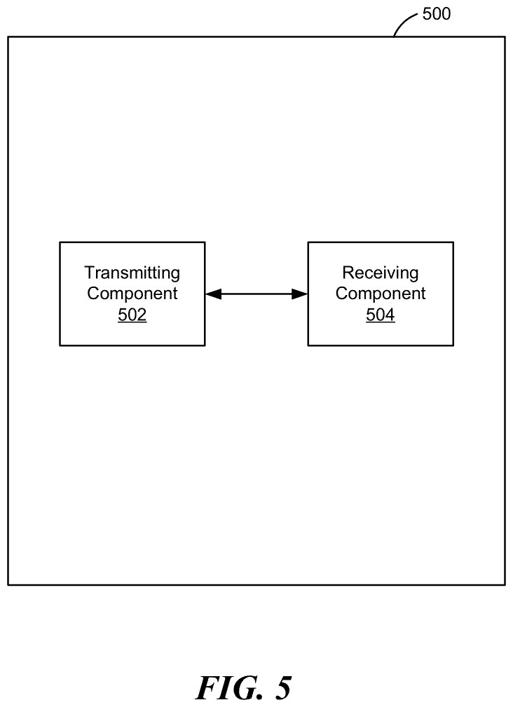

FIG. 5 is a block diagram of an example wireless communication device 500 that supports efficient delivery of clock quality information, in accordance with various aspects of the present disclosure. In some implementations, the wireless communication device 500 is configured to perform one or more steps of the process 700 described with reference to FIG. 7 or the process described with respect to FIG. 4. The wireless communication device 500 may be an example implementation of a base station 110 described above with reference to FIG. 1. For example, the wireless communication device 500 can be a chip, SoC, chipset, package or device that includes at least one modem (e.g., a Wi-Fi (IEEE 802.11) modem or a cellular modem), at least one processor, at least one radio, and at least one memory.

The wireless communication device 500 includes a transmitting component 502 and a receiving component 504. Portions of one or more of the components 502, 504 may be implemented at least in part in hardware or firmware. For example, the transmitting component 502 and receiving component 504 may be implemented at least in part by a modem. In some implementations, at least some of the components 502, 504 are implemented at least in part as software stored in a memory. For example, portions of one or more of the components 502, 504 can be implemented as non-transitory instructions (or “code”) executable by a processor to perform the functions or operations of the respective module.

The transmitting component 502 is configured to transmit clock quality information to a user equipment (UE) based on the clock quality reporting control information. The receiving component 504 is configured to receive clock quality reporting control information. In other aspects, the transmitting component 502 is configured to transmit a default clock quality to a UE, the default clock quality applying to an area of the network device.

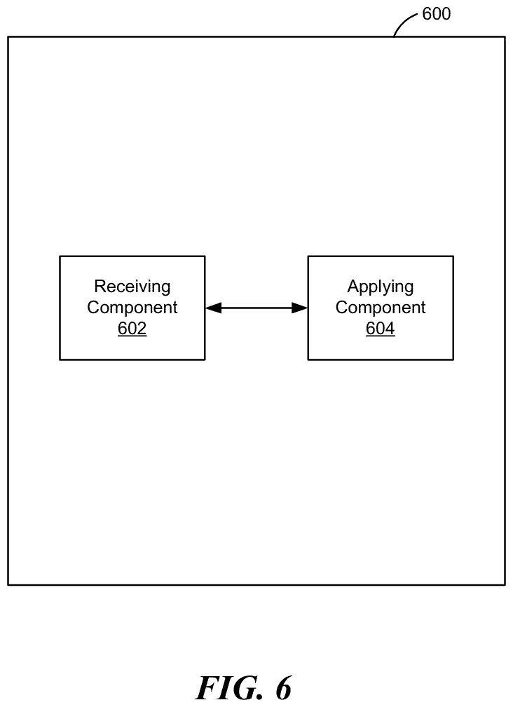

FIG. 6 is a block diagram of an example wireless communication device 600 that supports efficient delivery of clock quality information, in accordance with various aspects of the present disclosure. In some implementations, the wireless communication device 600 is configured to perform one or more steps of the process described with respect to FIG. 4. The wireless communication device 600 may be an example implementation of the UE 120 described above with reference to FIG. 1. For example, the wireless communication device 600 can be a chip, SoC, chipset, package or device that includes at least one modem (e.g., a Wi-Fi (IEEE 802.11) modem or a cellular modem), at least one processor, at least one radio, and at least one memory.

The wireless communication device 600 includes a receiving component 602 and an applying component 604. Portions of one or more of the components 602, 604 may be implemented at least in part in hardware or firmware. For example, the receiving component 602 and applying component 604 may be implemented at least in part by a modem and/or a processor and memory. In some implementations, at least some of the components 602, 604 are implemented at least in part as software stored in a memory. For example, portions of one or more of the components 602, 604, can be implemented as non-transitory instructions (or “code”) executable by a processor to perform the functions or operations of the respective module.

The receiving component 602 is configured to receive a first default clock quality for a first area. The receiving component 602 is also configured to receive a second default clock quality for a second area when the UE 120 leaves the first area and enters the second area. The applying component 604 is configured to apply the first default clock quality, when the UE 120 is located within the first area, and apply the second default clock quality, when the UE 120 is located within the second area.

FIG. 7 is a flow diagram illustrating an example process 700 performed, for example, by a network device, in accordance with various aspects of the present disclosure. The example process 700 is an example of efficient delivery of clock quality information to user equipment (UE).

As shown in FIG. 7, in some aspects, at block 702, the process 700 may include receiving clock quality reporting control information. For example, the base station (e.g., using the antenna 234, MOD/DEMOD 232, MIMO detector 236, receive processor 238, controller/processor 240, memory 242, and/or the like), or the core network, may receive the clock quality reporting control information. The clock quality reporting control information may indicate a clock quality detail level comprising information to be provided to the UE. The clock quality detail level may comprises a clock quality index, clock quality details, and/or an indication of whether a clock quality satisfies clock quality acceptance criteria for the UE. The network device may receive clock quality acceptance criteria associated with the indication of whether the clock quality satisfies the clock quality acceptance criteria for the UE. In some aspects, the clock quality details comprise a clock accuracy, a frequency stability, and/or a traceability to coordinated universal time (UTC). The clock reporting control information may be received from UE subscription information or an application function. The network device may receive, from a core network component, the clock quality reporting control information when establishing a context for the UE, when the network device comprises a base station.

In some aspects, at block 704, the process 700 may include transmitting clock quality information to a user equipment (UE) based on the clock quality reporting control information. For example, the base station (e.g., using the antenna 234, MOD/DEMOD 232, TX MIMO processor 230, transmit processor 220, controller/processor 240, memory 242, and/or the like) may transmit the clock quality information. In other aspects, the transmitting the clock quality information includes transmitting, to the UE, the clock quality information, based at least in part on the clock quality detail level. In still other aspects, the transmitting the clock quality information comprises transmitting the clock quality information via non-access stratum signaling when the network device comprises a core network component.

### Example Aspects

Aspect 1: An apparatus for wireless communication by a network device, comprising: at least one memory; and at least one processor coupled to the at least one memory, the at least one processor configured to: receive clock quality reporting control information; and transmit clock quality information to a user equipment (UE) based on the clock quality reporting control information.
Aspect 2: The apparatus of Aspect 1, wherein the clock quality reporting control information indicates a clock quality detail level comprising information to be provided to the UE; and the at least one processor configured to transmit is further configured to transmit, to the UE, the clock quality information, based at least in part on the clock quality detail level.
Aspect 3: The apparatus of Aspect 1 or 2, wherein the clock quality detail level comprises at least one of clock quality details or an indication of whether a clock quality satisfies clock quality acceptance criteria for the UE.
Aspect 4: The apparatus of any of the preceding Aspects, wherein the indication of whether the clock quality satisfies the clock quality acceptance criteria for the UE comprises an acceptable/non-acceptable indication.
Aspect 5: The apparatus of any of the preceding Aspects, wherein the at least one processor is further configured to receive the clock quality acceptance criteria associated with the indication of whether the clock quality satisfies the clock quality acceptance criteria for the UE; and the at least one processor configured to transmit is further configured to transmit, to the UE, the clock quality information, based at least in part on the clock quality acceptance criteria and the clock quality detail level comprising the indication of whether the clock quality satisfies the clock quality acceptance criteria for the UE.
Aspect 6: The apparatus of any of the preceding Aspects, wherein the clock quality details comprise at least one of a clock accuracy, a frequency stability, and a traceability to coordinated universal time (UTC).
Aspect 7: The apparatus of any of the preceding Aspects, wherein the at least one processor is further configured to receive the clock reporting control information from UE subscription information.
Aspect 8: The apparatus of any of the Aspects 1-6, wherein the at least one processor is further configured to receive the clock quality reporting control information from an application function (AF).
Aspect 9: The apparatus of any of the Aspects 1-6, wherein the at least one processor is further configured to receive, from a core network component, the clock quality reporting control information, wherein the network device comprises a base station.
Aspect 10: The apparatus of any of the preceding Aspects, wherein the at least one processor is further configured to transmit the clock quality information via non-access stratum signaling based at least in part on the network device comprising a core network component.
Aspect 11: A method of wireless communication by a network device, comprising: receiving clock quality reporting control information; and transmitting clock quality information to a user equipment (UE) based on the clock quality reporting control information.
Aspect 12: The method of Aspect 11, wherein the clock quality reporting control information indicates a clock quality detail level comprising information to be provided to the UE; and the transmitting the clock quality information includes transmitting, to the UE, the clock quality information, based at least in part on the clock quality detail level.
Aspect 13: The method of Aspect 11 or 12, wherein the clock quality detail level comprises at least one of clock quality details or an indication of whether a clock quality satisfies clock quality acceptance criteria for the UE.
Aspect 14: The method of any of the Aspects 11-13, wherein the indication of whether the clock quality satisfies the clock quality acceptance criteria for the UE comprises an acceptable/non-acceptable indication.
Aspect 15: The method of any of the Aspects 11-14, further comprising receiving the clock quality acceptance criteria associated with the indication of whether the clock quality satisfies the clock quality acceptance criteria for the UE, and the method transmits clock quality information to the UE based at least in part on the clock quality acceptance criteria and the clock quality detail level comprising the indication of whether the clock quality satisfies the clock quality acceptance criteria for the UE.
Aspect 16: The method of any of the Aspects 11-15, wherein the clock quality details comprise at least one of a clock accuracy, a frequency stability, and a traceability to coordinated universal time (UTC).
Aspect 17: The method of any of the Aspects 11-16, further comprising receiving the clock reporting control information from UE subscription information.
Aspect 18: The method of any of the Aspects 11-16, further comprising receiving the clock quality reporting control information from an application function.
Aspect 19: The method of any of the Aspects 11-16, further comprising receiving, from a core network component, the clock quality reporting control information when a context for the UE is established, wherein the network device comprises a base station.
Aspect 20: The method of any of the Aspects 11-19, wherein the transmitting the clock quality information comprises transmitting the clock quality information via non-access stratum signaling based at least in part on the network device comprising a core network component.
Aspect 21: A non-transitory computer-readable medium having program code recorded thereon, the program code executed by a processor and comprising: program code to receive clock quality reporting control information; and program code to transmit clock quality information to a user equipment (UE) based on the clock quality reporting control information.
Aspect 22: The non-transitory computer-readable medium of Aspect 21, wherein the clock quality reporting control information indicates a clock quality detail level comprising information to be provided to the UE; and the program code to transmit the clock quality information further comprises program code to transmit, to the UE, the clock quality information, based at least in part on the clock quality detail level.
Aspect 23: The non-transitory computer-readable medium of Aspect 21 or 22, wherein the clock quality detail level comprises at least one of clock quality details or an indication of whether a clock quality satisfies clock quality acceptance criteria for the UE.
Aspect 24: The non-transitory computer-readable medium of any of the Aspects 21-23, wherein the indication of whether the clock quality satisfies the clock quality acceptance criteria for the UE comprises an acceptable/non-acceptable indication.
Aspect 25: The non-transitory computer-readable medium of any of the Aspects 21-24, in which the program code further comprises program code to receive the clock quality acceptance criteria associated with the indication of whether the clock quality satisfies the clock quality acceptance criteria for the UE, and the program code to transmit clock quality information to the UE is based at least in part on the clock quality acceptance criteria and the clock quality detail level comprising the indication of whether the clock quality satisfies the clock quality acceptance criteria for the UE.
Aspect 26: An apparatus for wireless communication by a network device, comprising: means for receiving clock quality reporting control information; and means for transmitting clock quality information to a user equipment (UE) based on the clock quality reporting control information.
Aspect 27: The apparatus of Aspect 26, wherein the clock quality reporting control information indicates a clock quality detail level comprising information to be provided to the UE; and the means for transmitting the clock quality information further comprises means for transmitting, to the UE, the clock quality information, based at least in part on the clock quality detail level.
Aspect 28: The apparatus of Aspect 26-27, wherein the clock quality detail level comprises at least one of clock quality details or an indication of whether a clock quality satisfies clock quality acceptance criteria for the UE.
Aspect 29: The apparatus of any of the Aspects 26-28, wherein the indication of whether the clock quality satisfies the clock quality acceptance criteria for the UE comprises an acceptable/non-acceptable indication.
Aspect 30: The apparatus of any of the Aspects 26-29, further comprising means for receiving the clock quality acceptance criteria associated with the indication of whether the clock quality satisfies the clock quality acceptance criteria for the UE, and the means for transmitting clock quality information to the UE is based at least in part on the clock quality acceptance criteria and the clock quality detail level comprising the indication of whether the clock quality satisfies the clock quality acceptance criteria for the UE.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

1. An apparatus for wireless communication by a network device, comprising:
at least one memory; and
at least one processor coupled to the at least one memory, the at least one processor configured to:
receive clock quality reporting control information; and
transmit clock quality information to a user equipment (UE) based on the clock quality reporting control information.

2. The apparatus of claim 1, wherein the clock quality reporting control information indicates a clock quality detail level comprising information to be provided to the UE; and
the at least one processor configured to transmit is further configured to transmit, to the UE, the clock quality information, based at least in part on the clock quality detail level.

3. The apparatus of claim 2, wherein the clock quality detail level comprises at least one of a clock quality details or an indication of whether a clock quality satisfies clock quality acceptance criteria for the UE.

4. The apparatus of claim 3, wherein the indication of whether the clock quality satisfies the clock quality acceptance criteria for the UE comprises an acceptable/non-acceptable indication.

5. The apparatus of claim 3, wherein the at least one processor is further configured to receive the clock quality acceptance criteria associated with the indication of whether the clock quality satisfies the clock quality acceptance criteria for the UE; and
the at least one processor configured to transmit is further configured to transmit, to the UE, the clock quality information, based at least in part on the clock quality acceptance criteria and the clock quality detail level comprising the indication of whether the clock quality satisfies the clock quality acceptance criteria for the UE.

6. The apparatus of claim 3, wherein the clock quality details comprise at least one of a clock accuracy, a frequency stability, and a traceability to coordinated universal time (UTC).

7. The apparatus of claim 1, wherein the at least one processor is further configured to receive the clock reporting control information from UE subscription information.

8. The apparatus of claim 1, wherein the at least one processor is further configured to receive the clock quality reporting control information from an application function (AF).

9. The apparatus of claim 1, wherein the at least one processor is further configured to receive, from a core network component, the clock quality reporting control information, wherein the network device comprises a base station.

10. The apparatus of claim 1, wherein the at least one processor is further configured to transmit the clock quality information via non-access stratum signaling based at least in part on the network device comprising a core network component.

11. A method of wireless communication by a network device, comprising:
receiving clock quality reporting control information; and
transmitting clock quality information to a user equipment (UE) based on the clock quality reporting control information.

12. The method of claim 11, wherein the clock quality reporting control information indicates a clock quality detail level comprising information to be provided to the UE; and
the transmitting the clock quality information includes transmitting, to the UE, the clock quality information, based at least in part on the clock quality detail level.

13. The method of claim 12, wherein the clock quality detail level comprises at least one of clock quality details or an indication of whether a clock quality satisfies clock quality acceptance criteria for the UE.

14. The method of claim 13, wherein the indication of whether the clock quality satisfies the clock quality acceptance criteria for the UE comprises an acceptable/non-acceptable indication.

15. The method of claim 13, further comprising receiving the clock quality acceptance criteria associated with the indication of whether the clock quality satisfies the clock quality acceptance criteria for the UE, and the method transmits clock quality information to the UE based at least in part on the clock quality acceptance criteria and the clock quality detail level comprising the indication of whether the clock quality satisfies the clock quality acceptance criteria for the UE.

16. The method of claim 13, wherein the clock quality details comprise at least one of a clock accuracy, a frequency stability, and a traceability to coordinated universal time (UTC).

17. The method of claim 11, further comprising receiving the clock reporting control information from UE subscription information.

18. The method of claim 11, further comprising receiving the clock quality reporting control information from an application function.

19. The method of claim 11, further comprising receiving, from a core network component, the clock quality reporting control information when a context for the UE is established, wherein the network device comprises a base station.

20. (canceled)

21. A non-transitory computer-readable medium having program code recorded thereon, the program code executed by a processor and comprising:
program code to receive clock quality reporting control information; and
program code to transmit clock quality information to a user equipment (UE) based on the clock quality reporting control information.

22-30. (canceled)
